(19) United States
(12) Patent Application Publication
(10) Pub. No.: US 2004/0115356 A1
(43) Pub. Date: Jun. 17, 2004

(54) Integrated method for repairing multilayered colored and/or effect-producing paint coatings

(76) Inventors: Nicola Zarse, Munster (DE); Georg Wigger, Senden (DE); Roland Ratz, Everswinkel (DE)

Correspondence Address: BASF CORPORATION, ANNE GERRY SABOURIN, 26701 TELEGRAPH ROAD, SOUTHFIELD, MI, 48034-2442, US

(21) Appl. No.: 10/474,890

(22) PCT Filed: May 11, 2002
(86) PCT No.: PCT/EP02/05198

(30) Foreign Application Priority Data
May 18, 2001 (DE) 101 24 277.8

(51) Int. Cl. B05D 3/02; B05D 1/36; B05D 3/00

(52) U.S. Cl. 427/407.1; 427/385.5; 427/553

(57) ABSTRACT

The use of an aqueous two-component or multicomponent system comprising

(A) at least one binder component comprising at least one ionically and/or nonionically stabilized polyurethane which is saturated, unsaturated and/or grafted with olefinically unsaturated compounds, and

(B) at least one crosslinking component comprising at least one polyisocyanate,

to prevent shade shifts and/or effect shifts between the basecoat of an original finish and the basecoat of a refinish in the refinishing of a multicoat color and/or effect coating system, and also an integrated process for refinishing multicoat color and/or effect coating systems, in which the two-component or multicomponent system is used as a primer-surfacer for producing the original finish as part of an integrated wet-on-wet process.

The present invention relates to a novel process for refinishing multicoat color and/or effect coating systems. The present invention further relates to the multicoat and/or effect coating systems refinished using the novel process.

Integrated wet-on-wet processes for producing multicoat color and/or effect coating systems which comprise at least one functional coat, at least one color and/or effect basecoat, and at least one clearcoat are known from the European patent EP 0 788 523 B1.

The processes comprise

(1) applying aqueous primer-surfacers to primed or unprimed substrates,

(2) then drying the resultant primer-surfacer films (1) without fully curing them,

(3) coating the dried primer-surfacer films (2) with aqueous basecoat materials,

(4) then drying the resultant aqueous basecoat films (3) without fully curing them, and

(5) coating the dried aqueous basecoat films (4) with clearcoat materials,

(6) and then curing the films (2) and (4) and also the clear coat films (5) together, to give the functional coats, the color and/or effect basecoats, and the clearcoats.

The aqueous coating materials used in these processes are physically curable and comprise a water-dilutable polyurethane resin binder. The aqueous coating materials further comprise pigments and/or fillers, the ratio of binder to pigment being between 0.5:1 and 1.5:1.

The known aqueous coating materials permit the production of particularly thin primer-surfacer coats, antistonechip primer coats or functional coats without loss of stonechip resistance or deterioration in the masking of the unevennesses of the primed substrate. The known integrated wet-on-wet process is therefore particularly favorable from both an economic and an environmental standpoint.

If the known multicoat color and/or effect coating systems present, for example, on an automobile body have to be repaired on the line, in whole or in part, problems occur. For instance, the development of shade of the basecoat when applied to baked primer-surfacer coats is different than one applied to primer-surfacer coats which have undergone “only” initial drying. In the course of refinishing, therefore, the primer-surfacer has to be reapplied as well in order to match the shade of the original finish.

This results overall in the following multicoat construction:

Original finish:

primer (normally a cathodically deposited and baked electrocoat),

primer-surfacer coat,

basecoat, and

clearcoat, plus

Refinish:

primer-surfacer coat,

basecoat, and

clearcoat.

In comparison to the standard procedure, in which the primer-surfacer is crosslinked fully at relatively high temperatures before the aqueous basecoat material is applied (cf. the German patent application DE 199 30 552 A1), therefore, it is necessary to apply an additional coat, which makes the refinish of the integrated wet-on-wet process technically complex and therefore more susceptible to error and more expensive.

On the other hand, the standard procedure does not result in shade deviation between the basecoat of the original finish and the basecoat of the refinish. However, the standard procedure necessitates an additional baking step, leading to additional energy consumption and necessitating additional units such as forced air ovens.

Since, however, the known integrated wet-on-wet process for producing multicoat color and/or effect coating systems has numerous technical and economic advantages, it would be desirable to have a process for refinish whose result is the same as that of the standard process but without the application of a primer-surfacer coat.

The German patent applications DE 199 04 317 A1 and DE 198 55 125 A1 disclose aqueous multicomponent systems based on hydroxyl-containing polyurethanes and polyisocyanates. Besides the hydroxyl-containing polyurethanes, or instead of them, it is also possible to employ numerous other binders. The multicomponent systems are used in particular to produce clearcoats.

An object of the German patent application DE 199 04 317 A1 was to provide aqueous multicomponent systems which, especially in the course of prolonged storage, are infested and destroyed by microorganisms to a lesser extent if at all.

An object of the German patent application DE 198 155 125 A1 was to provide aqueous multicomponent systems which are easy to produce, homogeneous, easy to manage, low in solvent, proof against popping marks and splashes, and stable on forced drying, and which give matt coatings which do not exhibit surface defects or gray haze but instead are stable to weathering and resistant to gasoline.

The two German patent applications, therefore, do not give any indications or any incitement to use the multicomponent systems as primer-surfacers as part of an integrated wet-on-wet process so that when the multicoat color and/or effect coating system produced by the process is refinished there is no shade shift of the basecoat even in the absence of an additional primer-surfacer coat.

It is an object of the present invention to find a novel integrated process for refinishing multicoat color and/or effect coating systems, which

continues to have the advantages of the integrated wet-on-wet process for producing multicoat color

and/or effect coating systems of the prior art,

manages to effect refinishing without the application of an additional primer-surfacer coat, and

manages to produce the original finish without an additional baking step,

without any shade shift and/or effect shift of the basecoat of the refinish relative to the basecoat of the original finish.

The invention accordingly provides for the novel use of an aqueous two-component or multicomponent system comprising

(A) at least one binder component comprising at least one ionically and/or nonionically stabilized polyurethane which is saturated, unsaturated and/or grafted with olefinically unsaturated compounds, and

(B) at least one crosslinking component comprising at least one polyisocyanate,

to prevent shade shifts and/or effect shifts between the basecoat of an original finish and the basecoat of a refinish in the refinishing of a multicoat color and/or effect coating system.

In the text below, the novel use of a two-component or multicomponent system comprising at least one binder component (A) and at least one crosslinking component (B) is referred to as the “inventive use”.

The invention also provides the novel integrated process for refinishing multicoat color and/or effect coating systems, in which

1. the original finishes are produced by an integrated wet-on-wet process in which

1.1 at least one aqueous primer-surfacer is applied to a primed or unprimed substrate,

1.2 the resultant aqueous primer-surfacer film(s) 1.1 is (are) dried,

1.3 the dried primer-surfacer film(s) 1.2 is (are) overcoated with at least one aqueous basecoat material,

1.4 the resultant aqueous basecoat film(s) 1.3 is (are) dried without being cured completely, and

1.5 the dried aqueous basecoat film(s) 1.4 is (are) overcoated with at least one clearcoat material, and then

1.6 the resultant clearcoat film(s) 1.5 and also the films 1.2 and 1.4 are cured together, thermally or both thermally and with actinic radiation, to give the functional coat or primer-surfacer coat, the basecoat, and the clearcoat of the original finishes; and

2. the refinishes are produced by an integrated wet-on-wet process in which

2.1 at least one aqueous basecoat is applied to the original finishes,

2.2 the aqueous basecoat film(s) is (are) dried without being fully cured,

2.3 the dried aqueous basecoat film(s) 2.2 is (are) overcoated with at least one clearcoat material, and

2.4 the clearcoat film(s) 2.3 and the aqueous basecoat film(s) 2.2 are cured together, thermally or both thermally and with actinic radiation, to give the clearcoat and the basecoat of the refinish;

which comprises using at least one aqueous primer-surfacer 1.1 comprising

(A) at least one binder component comprising at least one ionically and/or nonionically stabilized polyurethane which is saturated, unsaturated and/or grafted with olefinically unsaturated compounds, and

(B) at least one crosslinking component comprising at least one polyisocyanate.

In the text below, the novel integrated process for refinishing multicoat color and/or effect coating systems is referred to as the “process of the invention”.

The invention additionally provides novel refinish multicoat color and/or effecting coating systems which are producible using the process of the invention and are referred to below as “multicoat systems of the invention”.

Further subject matter of the invention will emerge from the description.

In the light of the prior art it was surprising and unforeseeable for the skilled worker that the object on which the present invention was based might be achieved by means of the inventive use and the process of the invention. A particular surprise was that the inventive use and the process of the invention, and also the multicoat systems of the invention produced therewith, continue to have all of the economic and technological advantages of the prior art without its disadvantages, such as additional process steps for preventing shade shift and/or effect shift between the basecoats of the original finishes and the basecoats of the refinishes, on the one hand, or the baking of primer-surfacer films as part of the production of the original finishes, on the other.

In the process of the invention at least one, in particular one, two-component or multicomponent system, in particular a two-component system, is used to produce the functional coat or the primer-surfacer coat as part of the original finishing of the multicoat color and/or effect coating system.

The two-component system is curable thermally or both thermally and with actinic radiation (dual cure). For curing with actinic radiation it is possible to use electromagnetic radiation, such as near infrared (NIR), visible light, UV radiation or X-rays, especially UV radiation, and corpuscular radiation, such as electron beams.

The two-component system comprises a binder component (A) whose binder comprises as a key constituent at least one ionically and/or nonionically stabilized polyurethane which is saturated, unsaturated and/or grafted with olefinically unsaturated compounds.

Polyurethanes of this kind are known per se and are described in detail, for example, in

the German patent application DE 199 14 896 A1, column 1 lines 29 to 49, column 4 line 23 to column 11 line 5, and column 19 line 12 to column 20 line 6,

the German patent application DE 44 38 504 A1, page 2 line 58 to page 4 line 40 in conjunction with page 5 line 24 to page 7 line 33,

the German patent application DE 199 04 624 A1, page 2 line 35 to page 5 line 46 in conjunction with page 7 line 36 to page 8 line 14,

the German patent application DE 41 07 136 A1, page 2 line 23 to page 4 line 35 in conjunction with page 5 lines 23 to 59,

the German patent application DE 199 04 317 A1, page 9 line 44 to page 12 line 11 in conjunction with page 16 line 58 to page 17 line 2.

For further details, reference is made to the German patent applications cited at the outset.

The amount of the polyurethanes in the binder component (A) may vary very widely and is guided by the requirements of the individual case. The amount is preferably from 10 to 80, more preferably from 12 to 75, with particular preference from 14 to 70, with very particular preference from 16 to 65, and in particular from 16 to 60% by weight, based in each case on the solids of the binder component (A).

The crosslinking component (B) comprises at least one polyisocyanate.

The polyisocyanates contain on average per molecule at least 2.0, preferably more than 2.0, and in particular more than 2.5 isocyanate groups. In principle there is no upper limit on the number of isocyanate groups; in accordance with the invention, however, it is of advantage if the number does not exceed 15, preferably 12, with particular preference 10, with very particular preference 8.0, and in particular 6.0.

Examples of suitable polyisocyanates are isocyanato-containing polyurethane prepolymers which can be prepared by reacting polyols with an excess of diisocyanates and which are preferably of low viscosity.

Examples of suitable diisocyanates are isophorone diisocyanate (i.e., 5-isocyanato-1-isocyanatomethyl-1,3,3-trimethylcyclohexane), 5-isocyanato-1-(2-isocyanatoeth-1-yl)-1,3,3-trimethylcyclohexane, 5-isocyanato-1-(3-isocyanatoprop-1-yl)-1,3,3-trimethylcyclohexane, 5-isocyanato-(4-isocyanatobut-1-yl)-1,3,3-trimethylcyclohexane, 1-isocyanato-2-(3-isocyanatoprop-1-yl)cyclohexane, 1-isocyanato-2-(3-isocyanatoeth-1-yl)cyclohexane, 1-isocyanato-2-(4-isocyanatobut-1-yl)cyclohexane, 1,2-diisocyanatocyclobutane, 1,3-diisocyanatocyclobutane, 1,2-diisocyanatocyclopentane, 1,3-diisocyanatocyclopentane, 1,2-diisocyanatocyclohexane, 1,3-diisocyanatocyclohexane, 1,4-diisocyanatocyclohexane, dicyclohexylmethane 2,4′-diisocyanate, trimethylene diisocyanate, tetramethylene diisocyanate, pentamethylene diisocyanate, hexamethylene diisocyanate (HDI), ethylethylene diisocyanate, trimethylhexane diisocyanate, heptamethylene diisocyanate, or diisocyanates derived from dimer fatty acids, as sold under the commercial designation DDI 1410 by Henkel and described in the patents WO 97/49745 and WO 97/49747, especially 2-heptyl-3,4-bis(9-isocyanatononyl)-1-pentylcyclohexane, or 1,2-, 1,4- or 1,3-bis(isocyanatomethyl)cyclohexane, 1,2-, 1,4- or 1,3-bis(2-isocyanatoeth-1-yl)cyclohexane, 1,3-bis(3-isocyanatoprop-1-yl)cyclohexane, 1,2-, 1,4- or 1,3-bis(4-isocyanatobut-1-yl)cyclohexane, or liquid bis(4-isocyanatocyclohexyl)methane with a trans/trans content of up to 30% by weight, preferably 25% by weight, and in particular 20% by weight, as described in patent applications DE 44 14 032 A1, GB 1220717 A1, DE 16 18 795 A1 and DE 17 93 785 A1, preferably isophorone diisocyanate, 5-isocyanato-1-(2-isocyanato-eth-1-yl)-1,3,3-trimethylcyclohexane, 5-isocyanato-1-(3-isocyanatoprop-1-yl)-1,3,3-trimethyl-cyclohexane, 5-isocyanato-(4-isocyanatobut-1-yl)-1,3,3-trimethyl-cyclohexane, 1-isocyanato-2-(3-isocyanatoprop-1-yl)-cyclohexane, 1-isocyanato-2-(3-isocyanatoeth-1-yl)-cyclohexane, 1-isocyanato-2-(4-isocyanatobut-1-yl)-cyclohexane or HDI, especially HDI.

It is also possible to use polyisocyanates containing isocyanurate, biuret, allophanate, iminooxadiazinedione, urethane, urea, carbodiimide and/or uretdione groups, which are prepared in a customary and known manner from the diisocyanates described above. Examples of suitable preparation processes and polyisocyanates are known, for example, from the patents CA 2,163,591 A, U.S. Pat. No. 4,419,513, U.S. Pat. No. 4,454,317 A, EP 0 646 608 A, U.S. Pat. No. 4,801,675 A, EP 0 183 976 A1, DE 40 15 155 A1, EP 0 303 150 A1, EP 0 496 208 A1, EP 0 524 500 A1, EP 0 566 037 A1, U.S. Pat. No. 5,258,482 A1, U.S. Pat. No. 5,290,902 A1, EP 0 649 806 A1, DE 42 29 183 A1 or EP 0 531 820 A1, or are described in the German Patent Application DE 100 05 228.2, unpublished at the priority date of the present specification.

Also suitable, furthermore, are the high-viscosity polyisocyanates as described in the German Patent Application DE 198 28 935 A1, or the polyisocyanate particles surface-deactivated by urea formation and/or blocking, as per the European Patent Applications EP 0 922 720 A1, EP 1 013 690 A1 and EP 1 029 879 A1.

Also suitable, moreover, as polyisocyanates (B) are the adducts described in the German Patent Application DE 196 09 617 A1, namely adducts of polyisocyanates with dioxanes, dioxolanes and oxazolidines which contain isocyanate-reactive functional groups and still contain free isocyanate groups.

The amount of the polyisocyanates in the crosslinking component (B) may likewise vary greatly. It is guided in particular by their aggregate state (liquid or solid), which determines their miscibility with the binder component (A). Accordingly, it is advisable to employ solid or highly viscous polyisocyanates in the form of a solution in at least one inert organic solvent, in order to improve their miscibility with the binder component (A). The amount of the polyisocyanates in the crosslinking component (B) is preferably from 10 to 100, more preferably from 15 to 95, with particular preference from 20 to 90, with very particular preference from 25 to 85, and in particular from 30 to 80% by weight, based in each case of the crosslinking component (B) The amount of the polyurethanes on the one hand and of the polyisocyanates on the other in the two-component system may likewise vary very widely. It is guided in particular by the functionality, i.e., the number of isocyanate-reactive groups in the binder component (A), on the one hand, and by the functionality of the polyisocyanates in the crosslinking component (B), on the other. In general it is advisable to choose the amount so as to give a ratio of isocyanate groups to isocyanate-reactive groups of from 2:1 to 1:2, preferably from 1.8:1 to 1:1.8, with particular preference from 1.6:1 to 1:1.6, with very particular preference from 1.4:1 to 1:1.4, and in particular from 1.2:1 to 1:1.2.

Besides the above-described polyurethanes and polyisocyanates, the two-component systems may also include at least one pigment (C). The pigments (C) may be mixed in by way of the binder component (A) and/or the cross-linking component (B). Preferably, they are mixed in by way of the binder component (A).

The pigments (C) are preferably selected from the group consisting of color and/or effect pigments, fluorescent pigments, electrically conductive pigments, and magnetically shielding pigments, metal powders, organic and inorganic, transparent and opaque fillers, and nanoparticles (called “pigments” below).

Examples of suitable effect pigments (C) are metal flake pigments such as commercially customary aluminum bronzes, aluminum bronzes chromated as per DE 36 36 183 A1, and commercially customary stainless steel bronzes, and also nonmetallic effect pigments, such as pearlescent pigments and interference pigments, for example, platelet-shaped effect pigments based on iron oxide with a shade from pink to brownish red, or liquid-crystalline effect pigments. For further details, refer to Römpp Lexikon Lacke und Druckfarben, Georg Thieme Verlag, 1998, page 176, “effect pigments” and pages 380 and 381, “metal oxide/mica pigments” to “metal pigments”, and to the patent applications and patents DE 36 36 156 A1, DE 37 18 446 A1, DE 37 19 804 A1, DE 39 30 601 A1, EP 0 068 311 A1, EP 0 264 843 A1, EP 0 265 820 A1, EP 0 283 852 A1, EP 0 293 746 A1, EP 0 417 567 A1, U.S. Pat. No. 4,828,826 A and U.S. Pat. No. 5,244,649 A.

Examples of suitable inorganic color pigments (C) are white pigments such as titanium dioxide, zinc white, zinc sulfide or lithopones; black pigments such as carbon black, iron manganese black or spinel black; chromatic pigments such as chromium oxide, chromium oxide hydrate green, cobalt green or ultramarine green, cobalt blue, ultramarine blue or manganese blue, ultramarine violet or cobalt and manganese violet, red iron oxide, cadmium sulfoselenide, molybdate red or ultramarine red; brown iron oxide, mixed brown, spinel phases and corundum phases or chrome orange; or yellow iron oxide, nickel titanium yellow, chrome titanium yellow, cadmium sulfide, cadmium zinc sulfide, chrome yellow or bismuth vanadate.

Examples of suitable organic color pigments (C) are monoazo pigments, disazo pigments, anthraquinone pigments, benzimidazole pigments, quinacridone pigments, quinophthalone pigments, diketopyrrolopyrrole pigments, dioxazine pigments, indanthrone pigments, isoindoline pigments, isoindolinone pigments, azomethine pigments, thioindigo pigments, metal complex pigments, perinone pigments, perylene pigments, phthalocyanine pigments, or aniline black.

For further details, refer to Römpp Lexikon Lacke und Druckfarben, Georg Thieme Verlag, 1998, pages 180 and 181, “iron blue pigments” to “black iron oxide”, pages 451 to 453, “pigments” to “pigment volume concentration”, page 563, “thioindigo pigments”, page 567, “titanium dioxide pigments”, pages 400 and 467, “naturally occurring pigments”, page 459, “polycyclic pigments”, page 52, “azomethine pigments”, “azo pigments”, and page 379, “metal complex pigments”.

Examples of fluorescent pigments (C) (daylight-fluorescent pigments) and bis(azomethine) pigments.

Examples of suitable electrically conductive pigments (C) are titanium dioxide/tin oxide pigments.

Examples of magnetically shielding pigments (C) are pigments based on iron oxides or chromium dioxide.

Examples of suitable metal powders (C) are powders of metals and metal alloys comprising aluminum, zinc, copper, bronze or brass.

Examples of suitable organic and inorganic fillers (C) are chalk, calcium sulfates, barium sulfate, silicates such as talc, mica or kaolin, silicas, oxides such as aluminum hydroxide or magnesium hydroxide, or organic fillers such as polymer powders, especially those of polyamide or polyacrylonitrile. For further details, refer to Römpp Lexikon Lacke und Druckfarben, Georg Thieme Verlag, 1998, pages 250 ff., “fillers”.

Furthermore it is of advantage to use mixtures of platelet-shaped inorganic fillers such as talc or mica and non-platelet-shaped inorganic fillers such as chalk, dolomite, calcium sulfates or barium sulfate, since by this means the viscosity and rheology may be adjusted very effectively.

Examples of suitable transparent fillers (C) are those based on silica, alumina or zirconium oxide.

Suitable nanoparticles (C) are selected from the group consisting of hydrophilic and hydrophobic, especially hydrophilic, nanoparticles based on silica, alumina, zinc oxide, zirconium oxide, and the polyacids and heteropolyacids of transition metals, preferably of molybdenum and tungsten, having a primary particle size <50 nm, preferably from 5 to 50 nm, in particular from 10 to 30 nm. Preferably, the hydrophilic nanoparticles have no flatting effect. Particular preference is given to using nanoparticles based on silica.

Very particular preference is given to using hydrophilic pyrogenic silicas, whose agglomerates and aggregates have a catenated structure and which can be prepared by the flame hydrolysis of silicon tetrachloride in an oxyhydrogen flame. They are sold, for example, by Degussa under the brand name Aerosil®. Very particular preference is also given to using precipitated waterglasses, such as nanohectorites, which are sold, for example, by Südchemie under the brand name Optigel® or by Laporte under the brand name Laponite®.

The amount of the pigments (C) in the two-component systems may vary very widely. The amount is preferably set so as to give a pigment/binder ratio of from 1:10 to 5:1, more preferably from 1:8 to 4.5:1, with particular preference from 1:6 to 4:1, with particular preference from 1:4 to 3.5:1, and in particular from 1:2 to 3:1.

Instead of or in addition to the above-described pigments (C), the powders of the invention may further comprise at least one additive (D). The additives (D) may be mixed in by way of binder component (A) and/or the crosslinking component (B). Preferably they are mixed by way of the binder component (A).

Examples of suitable additives (D) are binders curable physically, thermally, both thermally and with actinic radiation, and with actinic radiation only, these binders being different than the polyurethanes described above; crosslinking agents different than the polyisocyanates described above; molecularly dispersely soluble dyes; light stabilizers, such as UV absorbers and reversible free-radical scavengers (HALS); antioxidants; low- and high-boiling (“long”) organic solvents; devolatilizers; wetting agents; emulsifiers; slip additives; polymerization inhibitors; thermal crosslinking catalysts; thermolabile free-radical initiators; photoinitiators and photocoinitiators; thermally curable reactive diluents; adhesion promoters; leveling agents; film formation auxiliaries; rheology assistants (thickeners); flame retardants; corrosion inhibitors; free-flow aids; waxes; siccatives; biocides and/or flatting agents, as they are described, for example, in the textbook “Lackadditive” [Additives for Coatings] by Johan Bieleman, Wiley-VCH, Weinheim, New York, 1998, or in the German patent application DE 199 14 896 A1, column 14 line 26 to column 15 line 46, in detail. For further details, refer to the above-cited German patent applications DE 199 04 317 A1 and DE 198 55 125 A1.

In terms of its method, the preparation of the binder components (A) and of the crosslinking components (B) and also of the two-component systems comprising them has no special features but instead takes place with the aid of customary and known mixing methods and apparatus such as stirred tanks, stirred mills, Ultraturrax, inline dissolvers, static mixers, toothed wheel dispersers, pressure release nozzles and/or microfluidizers.

The process of the invention starts from a primed or unprimed substrate, in particular a primed substrate.

Suitable substrates are all those whose surface is undamaged by the use of heat and/or actinic radiation in connection with the curing of the films that are present thereon. The substrates preferably comprise metals, plastics, wood, ceramic, stone, textile, fiber composites, leather, glass, glass fibers, glasswool and rockwool, mineral- and resin-bound building materials, such as plasterboard and cement slabs or roof tiles, and also composites of these materials.

Accordingly, the process of the invention is not only outstandingly suitable for applications in the fields of automotive OEM finishing and automotive refinish but is also suitable for the coating of constructions indoors and out, and of doors, windows and furniture, for industrial coating. including coil coating, container coating, and the impregnation and/or coating of electrical components, and for the coating of white goods, including domestic appliances, boilers, and radiators.

In the context of the industrial coatings it is suitable for the coating of virtually all parts and articles for private or industrial use, such as domestic appliances, small metal parts such as nuts and bolts, hubcaps, wheel rims, packaging, or electrical components, such as motor windings or transformer windings.

The process of the invention is preferably used in the field of automotive finishing.

In the case of electrically conductive substrates it is possible to use primers produced conventionally from electrocoat materials. Both anodic and cathodic electrocoat materials are suitable for this purpose, but especially cathodic electrocoat materials. The cathodically deposited electrocoat films may be merely dried or partly cured. The electrocoat films in question may then be overcoated with the primer-surfacers, aqueous basecoat materials, and clearcoat materials and cured together with them (extended integrated wet-on-wet process).

Examples of suitable cathodic electrocoat materials and, where appropriate, of wet-on-wet processes involving electrocoat films are described in the Japanese patent application 1975-142501 (Japanese laid-open specification JP 52-065534 A2, Chemical Abstracts No. 87: 137427) or in the patents U.S. Pat. No. 4,375,498 A1, U.S. Pat. No. 4,537,926 A1, U.S. Pat. No. 4,761,212 A1, EP 0 529 335 A1, DE 41 25 459 A1, EP 0 595 186 A1, EP 0 074 634 A1, EP 0 505 445 A1, DE 42 35 778 A1, EP 0 646 420 A1, EP 0 639 660 A1, EP 0 817 648 A1, DE 195 12 017 C1, EP 0 192 113 A2, DE 41 26 476 A1, and WO 98/07794.

Unfunctionalized and/or apolar plastics surfaces may be subjected before coating in a known manner to a pretreatment, such as with a plasma or by flaming, or may be provided with a water-based primer.

In the context of the process of the invention, the original finish is produced by means of an integrated wet-on-wet process.

In the first step of the process at least one, especially one, of the above-described two-component primer-surfacers for use in accordance with the invention is applied to the substrates described above.

In terms of its method, the application of the two-component primer surfacers has no special features but may instead take place by any customary application method, such as spraying knife coating, brushing, flow coating, dipping, trickling or rolling, for example. It is preferred to use spray application methods, such as compressed air spraying, airless spraying, high-speed rotating, electrostatic spray application (ESTA), alone or in conjunction with hot spray application such as hot air spraying, for example. These application methods may of course also be used for applying the aqueous basecoat materials and also the clearcoat materials.

In the second step of the process, the resultant primer-surface film is dried without being crosslinked fully. The drying may be assisted by heat, in which case temperatures of 80, preferably 70° C. should not be exceeded. Moreover, the drying may be accelerated by means of laminar air flows and/or by reducing the atmospheric humidity. It is preferred to employ drying times of from 30 seconds to two hours, preferably from one minute to one hour, and in particular from one minute to 45 minutes.

In the third step of the process, the dried primer-surfacer film is overcoated with at least one, especially one, aqueous basecoat material. The resultant aqueous basecoat film is dried without being fully crosslinked, using the methods described above.

Examples of suitable aqueous basecoat materials which may be used in the process of the invention are known from the patents and patent applications EP 0 089 497 A1, EP 0 256 540 A1, EP 0 260 447 A1, EP 0 297 576 A1, WO 96/12747, EP 0 523 610 A1, EP 0 228 003 A1, EP 0 397 806 A1, EP 0 574 417 A1, EP 0 531 510 A1, EP 0 581 211 A1, EP 0 708 788 A1, EP 0 593 454 A1, DE-A-43 28 092 A1, EP 0 299 148 A1, EP 0 394 737 A1, EP 0 590 484 A1, EP 0 234 362 A1, EP 0 234 361 A1, EP 0 543 817 A1, WO 95/14721, EP 0 521 928 A1, EP 0 522 420 A1, EP 0 522 419 A1, EP 0 649 865 A1, EP 0 536 712 A1, EP 0 596 460 A1, EP 0 596 461 A1, EP 0 584 818 A1, EP 0 669 356 A1, EP 0 634 431 A1, EP 0 678 536 A1, EP 0 354 261 A1, EP 0 424 705 A1, WO 97/49745, WO 97/49747, EP 0 401 565 A1, and EP 0 817 684 A1, column 5 lines 31 to 45.

In the further course of the process of the invention the dried aqueous basecoat film is overcoated with at least one, especially one, clearcoat material to give a clearcoat film. Examples of suitable clearcoat materials are described in the patent applications specified at the outset, in particular in the German patent application DE 199 14 896 A1, column 17 line 57 to column 18 line 30. Unless they are powder coating materials, the application methods described above may be employed. Examples of suitable application methods for powder coating materials are described, for example, in the Lacke+Farben AG product information leaflet “Pulverlacke” [Powder Coating Materials], 1990.

Subsequently, the dried primer-surfacer film, the aqueous basecoat film and the clearcoat film, and also the electrocoat film where appropriate, are cured together thermally, or both thermally and with actinic radiation. This gives the original finish of the multi-coat color and/or effect coating system, comprising or consisting of at least one functional coat, at least one color and/or effect (aqueous) basecoat, and at least one clearcoat.

Thermal curing may take place in customary and known forced air ovens or using IR lamps. It is preferred to employ temperatures from 80 to 180, preferably from 90 to 170, with particular preference from 100 to 165, with very particular preference from 110 to 160, and in particular from 120 to 155° C. The duration of thermal curing may be from one minute to 3 hours, preferably from 5 minutes to 2 hours, with particular preference from 10 minutes to one hour, with very particular preference from 15 minutes to one hour and in particular from 15 to 45 minutes.

For actinic radiation exposure, suitable radiation sources include those such as high-pressure or low-pressure mercury vapor lamps, which may be doped with lead in order to open up a radiation window of up to 405 nm, or electron beam sources. Further examples of suitable methods and apparatus for curing with actinic radiation are described in the German patent application DE 198 18 735 A1, column 10 lines 31 to 61.

In the further course of the process of the invention the above-described original finish, as a whole, or the damage sites present in the original finish, is or are overcoated with a refinish. The refinish is applied by an integrated wet-on-wet process.

In this process first of all at least one, especially one, aqueous basecoat material is applied to the original finish. The aqueous basecoat material used here is one which, following its full curing, is able to bring about the same shade and/or the same effect as the aqueous basecoat of the original finish. Preferably, the aqueous basecoat materials used to produce the refinish are physically identical or almost identical to the aqueous basecoat materials used to produce the original finish. As described for the production of the original finish, the aqueous basecoat film is dried without being fully cured. Subsequently, the dried aqueous basecoat film is overcoated with at least one, especially one, clearcoat material, after which the resultant clearcoat film and the aqueous basecoat film are cured together, thermally or both thermally and with actinic radiation. This is done using the methods and apparatus described above. The result is the refinish of the multicoat color and/or effect coating system, comprising or consisting of basecoat and the clearcoat.

The thickness of the primer-surfacer coats produced with the process of the invention is preferably from 10 to 100, more preferably from 10 to 80, with particular preference from 10 to 60, with very particular preference from 10 to 40, and in particular from 10 to 30 μm.

The thickness of the basecoats produced with the process of the invention is preferably from 5 to 50, more preferably from 7.5 to 40, with particular preference from 7.5 to 30, with very particular preference from 7.5 to 25, and in particular from 7.5 to 20 μm.

The thickness of the clearcoats produced with the process of the invention is preferably from 10 to 100, more preferably from 15 to 90, with particular preference from 15 to 80, with very particular preference from 20 to 70, and in particular from 20 to 60 μm.

The multicoat color and/or effect coating systems produced using the process of the invention, comprising original finish and automotive refinish, exhibit excellent leveling, a uniformly smooth surface, a high level of intercoat adhesion, and outstanding appearance properties. Although the refinish contains no primer-surfacer coat or functional coat, the shift in shade and/or shift in effect between the original finish and the refinish, if it occurs at all, is negligible from a performance standpoint.

### INVENTIVE EXAMPLE AND COMPARATIVE EXAMPLES C1 to C3

### Preparation Example 1

The Preparation of an Aqueous Dispersion Comprising a Polyurethane

For the inventive and comparative examples, the aqueous dispersion of a polyurethane was prepared in accordance with the instructions given in the German patent application DE 44 38 504 A1, page 5 lines 24 to 42, “1. Preparation of water-dilutable polyurethanes; 1.1 Polyurethane resin”.

### Preparation Example 2

The Preparation of a Binder Component (A) for Use in the Inventive Example and the Comparative Examples C2 and C3

The binder component (A) was prepared by mixing the following constituents in the stated sequence and homogenizing the resulting mixture:

30 parts by weight of the polyurethane dispersion from Preparation Example 1,

0.6 part by weight of a leveling agent,

10 parts by weight of deionized water,

2.0 parts by weight of an antifoam,

0.1 part by weight of N,N-dimethylethanolamine,

5 parts by weight of titanium dioxide,

10 parts by weight of talc,

4.0 parts by weight of blanc fixe (barium sulfate pigment from Sachtleben),

0.2 part by weight of a pyrogenic silica (Aerosil® R 972 from Degussa), and

0.5 part by weight of Flammruβ 101 (lamp black from Degussa).

### Preparation Example 3

### The Preparation of a Primer-Surfacer for Use in the Comparative Examples C2 and C3

The primer-surfacer was prepared by mixing 62.4 parts by weight of the binder component (A) from Preparation Example 2 and a mixture of 32 parts by weight of the polyurethane dispersion of Preparation Example 1,

2 parts by weight of an amino resin (Cymel® 327 from Cytec),

2.0 parts by weight of butyl diglycol, and

1.6 parts by weight of deionized water and homogenizing the resulting mixture.

### Preparation Example 4

The Preparation of a Two-component Primer-surfacer for Use in the Inventive Example

The two-component primer-surfacer for use in accordance with the invention was prepared by mixing

62.4 parts by weight of the binder component (A) from Preparation Example 2,

32 parts by weight of the polyurethane dispersion of Preparation Example 1,

2 parts by weight of butyl diglycol, and

1.6 parts by weight of deionized water, and also

10 parts by weight of a crosslinking component (B) comprising a commercial hexamethylene diisocyanate oligomer of the isocyanurate type (Desmodur® N 3600 from Bayer AG) and butyl diglycol acetate in a weight ratio of 67:33.

For application, the two-component primer-surfacer was adjusted using deionized water to a processing viscosity of 30 seconds in the DIN 4 cup.

### Preparation Example 5

The Preparation of a Baking Primer-Surfacer for Use in Comparative Example C1

The baking primer-surfacer was prepared in accordance with example 5 page 12 lines 42 to 53 of the German Patent DE 199 30 555 C1.

### Comparative Example C1

The Refinish of a Multicoat Color and Effect Coating System Comprising A Baked Primer-Surfacer From Preparation Example 5

The baking primer-surfacer of Preparation Example 5 was applied to steel panels, which had been coated with a customary and known, cathodically deposited and baked electrocoat material, in a wet film thickness such that baking at 1550° C. for 30 minutes gave a primer-surfacer coat with a film thickness of 35 μm.

The primer-surfacer coat was coated by the wet-on-wet process with a commercially customary metallic aqueous basecoat material and a commercially customary two-component clearcoat material. The aqueous basecoat film and the clearcoat film were baked together at 130° C. for 30 minutes. This gave an original finish consisting of an aqueous basecoat with a dry film thickness of 15 μm and a clearcoat with a dry film thickness of 35 μm.

To simulate a refinish, half of the coated surfaces of the steel panels was again coated by the wet-on-wet process with the commercially customary metallic aqueous basecoat material and the commercially customary two-component clearcoat material, as described above, so that the resulting refinish comprised an aqueous basecoat with a dry film thickness of 15 μm and clearcoat with a dry film thickness of 35 μm.

Colorimetric comparison between the original finish and the refinish did not reveal any shade shift.

### Comparative Example C2

The Refinish of a Multicoat Color and Effect Coating System Comprising a Primer-Surfacer from Preparation Example 3

The primer-surfacer of Preparation Example 3 was applied to steel panels, which had been coated with a customary and known, cathodically deposited and baked electrocoat material. The resultant primer-surfacer film was flashed off at room temperature for 5 minutes and dried at 70° C. for 5 minutes. The dried primer-surfacer film was coated by the wet-on-wet process with a commercially customary metallic aqueous basecoat material and a commercially customary two-component clearcoat material. The primer-surfacer film, the metallic aqueous basecoat film and the two-component clearcoat film were baked together at 130° C. for 30 minutes (cf. also page 5 lines 11 to 22 of the European Patent EP 0 788 523 B1). This gave an original finish consisting of a functional coat with a dry film thickness of 15 μm, an aqueous basecoat with a dry film thickness of 15 μm, and a clearcoat with a dry film thickness of 35 μm.

To simulate a refinish, half of the coated surfaces of the steel panels was again coated by the wet-on-wet process with the commercially customary metallic aqueous basecoat material and the commercially customary two-component clearcoat material, as described above, so that the resulting refinish comprised an aqueous basecoat with a dry film thickness of 15 μm and clearcoat with a dry film thickness of 35 μm.

Colorimetric comparison between the original finish and the refinish revealed a shade shift ΔE of 2.0.

### Comparative Example C3

The Refinish of a Multicoat Color and Effect Coating System Comprising a Primer-Surfacer from Preparation Example 3

The primer-surfacer of Preparation Example 3 was applied to steel panels, which had been coated with a customary and known, cathodically deposited and baked electrocoat material. The resultant primer-surfacer film was flashed off at room temperature for 5 minutes and dried at 70° C. for 5 minutes. The dried primer-surfacer film was coated by the wet-on-wet process with a commercially customary metallic aqueous basecoat material and a commercially customary two-component clearcoat material. The primer-surfacer film, the metallic aqueous basecoat film and the two-component clearcoat film were baked together at 130° C. for 30 minutes (cf. also page 5 lines 11 to 22 of the European Patent EP 0 788 523 B1). This gave an original finish consisting of a functional coat with a dry film thickness of 15 μm, an aqueous basecoat with a dry film thickness of 15 μm, and a clearcoat with a dry film thickness of 35 μm.

To simulate a refinish, half of the coated surfaces of the steel panels were again coated by the wet-on-wet process with the commercially customary metallic aqueous basecoat material and the commercially customary two-component clearcoat material, as described above, so that the resulting refinish comprised a functional coat with a dry film thickness of 15 μm, an aqueous basecoat with a dry film thickness of 15 μm, and a clearcoat with a dry film thickness of 35 μm.

Colorimetric comparison between the original finish and the refinish did not reveal any shade shift.

### Inventive Example

The Refinish of a Multicoat Color And/Or Effect Coating System by the Process of the Invention

The primer-surfacer from Preparation Example 4 was applied to steel panels which had been coated with a customary and known, cathodically deposited and baked electrocoat material. The resultant primer-surfacer film was flashed off at room temperature for 5 minutes and dried at 70° C. for 5 minutes. The dried primer-surfacer film was coated with commercially customary metallic aqueous basecoat material and the commercially customary two-component clearcoat material by the wet-on-wet process. The primer-surfacer film, the metallic aqueous basecoat film, and the two-component clearcoat film were baked together at 130° C. for 30 minutes. This gave an original finish consisting of a functional coat with a dry film thickness of 15 μm, an aqueous basecoat with a dry film thickness of 15 μm, and a clearcoat with a dry film thickness of 35 μm.

To simulate a refinish, half of the coated surfaces of the steel panels were again coated with the commercially customary metallic aqueous basecoat material and the commercially customary two-component clearcoat material, as described above, by the wet-on-wet process so that the resulting refinish comprised an aqueous basecoat with a dry film thickness of 15 μm and a clearcoat with a dry film thickness of 35 μm.

Colorimetric comparison between the original finish and the refinish revealed a shade shift ΔE of only 0.5.

What is claimed is:

1. The use of an aqueous two-component or multicomponent system comprising
(A) at least one binder component comprising at least one ionically and/or nonionically stabilized polyurethane which is saturated, unsaturated and/or grafted with olefinically unsaturated compounds, and
(B) at least one crosslinking component comprising at least one polyisocyanate,
to prevent shade shifts and/or effect shifts between the basecoat of an original finish and the basecoat of a refinish in the refinishing of a multicoat color and/or effect coating system.

2. The use as claimed in claim 1, wherein the original finish of the multicoat color and/or effect coating system comprises at least one primer-surfacer coat or functional coat, at least one color and/or effect aqueous basecoat, and at least one clearcoat.

3. The use as claimed in claim 2, wherein the original finish of the multicoat color and/or effect coating system comprises at least one primer coat.

4. The use as claimed in claim 3, wherein at least one cathodically deposited electrodeposition coat is used as the primer coat.

5. The use as claimed in any of claims 1 to 4, wherein the refinish of the multicoat color and/or effect coating system comprises at least one color and/or effect aqueous basecoat and at least one clearcoat.

6. The use as claimed in any of claims 1 to 5, wherein the two-component or multicomponent system is used to produce the primer-surfacer coat or functional coat of the original finish of the multicoat color and/or effect coating system.

7. An integrated process for refinishing a multicoat color and/or effect coating system, in which
1. the original finish is produced by an integrated wet-on-wet process in which
1.1 at least one aqueous primer-surfacer is applied to a primed or unprimed substrate,
1.2 the resultant aqueous primer-surfacer film(s) 1.1 is (are) dried,
1.3 the dried primer-surfacer film(s) 1.2 is (are) overcoated with at least one aqueous basecoat material,
1.4 the resultant aqueous basecoat film(s) 1.3 is (are) dried without being cured completely, and
1.5 the dried aqueous basecoat film(s) 1.4 is (are) overcoated with at least one clearcoat material, and then
1.6 the resultant clearcoat film(s) 1.5 and also the films 1.2 and 1.4 are cured together, thermally or both thermally and with actinic radiation, to give the functional coat or primer-surfacer coat, the basecoat, and the clearcoat of the original finish; and
2. the refinish is produced by an integrated wet-on-wet process in which
2.1 at least one aqueous basecoat is applied to the original finish,
2.2 the aqueous basecoat film(s) is (are) dried without being fully cured,
2.3 the dried aqueous basecoat film(s) 2.2 is (are) overcoated with at least one clearcoat material, and
2.4 the clearcoat film(s) 2.3 and the aqueous basecoat film(s) 2.2 are cured together, thermally or both thermally and with actinic radiation, to give the clearcoat and the basecoat of the refinishes;
which comprises using at least one aqueous primer-surfacer 1.1 comprising
(A) at least one binder component comprising at least one ionically and/or nonionically stabilized polyurethane which is saturated, unsaturated and/or grafted with olefinically unsaturated compounds, and
(B) at least one crosslinking component comprising at least one polyisocyanate.

8. The process as claimed in claim 7, wherein the substrate is electrically conductive.

9. The process as claimed in claim 8, wherein the substrate is primed by connecting it as the cathode, applying thereto at least one cathodically depositable electrocoat material and curing the resultant electrocoat film(s) alone or as part of the integrated process together with the films 1.2, 1.4 and 1.5.

10. The process as claimed in any of claims 7 to 9, wherein electromagnetic radiation and/or corpuscular radiation is used as the actinic radiation.

11. The process as claimed in claim 10, wherein near infrared (NIR), visible light, UV radiation or X-rays are used as the electromagnetic radiation and electron beams are used as the corpuscular radiation.

12. The process as claimed in any of claims 7 to 11, wherein the primer-surfacers 1.1 comprise pigments (C).

13. The process as claimed in claim 12, wherein the pigments (C) are selected from the group consisting of color and/or effect pigments, fluorescent pigments, electrically conductive pigments, and magnetically shielding pigments, metal powder, organic and inorganic, transparent and opaque fillers, and nanoparticles.

14. The process as claimed in any of claims 7 to 13, wherein vehicle bodies or parts thereof are used as substrates.
